(19) United States
(12) Patent Application Publication
(10) Pub. No.: US 2009/0205797 A1
(43) Pub. Date: Aug. 20, 2009

(54) FORMING FABRIC WITH EXTENDED SURFACE

(76) Inventors: Lippi A. Fernandes, Overijssel (NL); Martin Ringer, Lancashire (GB); Antony Morton, Yorkshire (GB); John Jeffery, Lancashire (GB); Justin Payne, Lancashire (GB)

Correspondence Address: TAYLOR & AUST, P.C., P.O. Box 560, 142. S Main Street, Avilla, IN, 46710, US

(21) Appl. No.: 12/353,367

(22) Filed: Jan. 14, 2009

Related U.S. Application Data
(63) Continuation of application No. PCT/EP2007/057142, filed on Jul. 12, 2007.

(51) Int. Cl. D21F 11/00; B32B 5/02

(52) U.S. Cl. 162/203; 442/59; 442/43

(57) ABSTRACT

A fabric for an advanced dewatering system having a woven fabric, the woven fabric having a paper side and a roll side, the paper side having a paper side surface and the roll side having a roll side surface and a polymer material. The polymer material is deposited onto the fabric and extends above the paper side surface. The polymer material has at least one of a random pattern, a random motif, a pseudo-random pattern, a pseudo-random motif, a predetermined pattern, and a predetermined motif.

### CROSS REFERENCE TO RELATED APPLICATIONS

This is a continuation of PCT application No. PCT/EP2007/057142, entitled “FORMING FABRIC WITH EXTENDED SURFACE”, filed Jul. 12, 2007, which claims priority to U.S. patent application Ser. No. 11/486,783, entitled “FORMING FABRIC WITH EXTENDED SURFACE”, filed Jul. 14, 2006, each of which are incorporated herein by reference.

### BACKGROUND OF THE INVENTION

1. Field of the Invention

The present invention relates to a fabric used in papermaking. More specifically, the present invention relates to forming fabrics used in the forming section of a papermaking machine, and more specifically, to a forming fabric for use in tissue making. The present invention further relates to a method of making a fibrous web, and more specifically, to a method of making a tissue web.

2. Description of the Related Art

In the art of papermaking, multiple steps occur from the introduction of a pulp slurry to the output of a finished paper product. The initial introduction of the slurry is at the portion of a papermaking machine known as the wet end. Here, the slurry, or fiber suspension, is initially dewatered when the slurry is introduced onto a moving forming fabric in the forming section of the papermaking machine. Varying amounts of water are removed from the slurry through the forming fabric, resulting in the formation of a fibrous web on the surface of the forming fabric.

Forming fabrics address not only the dewatering of the slurry, but also the sheet formation and, therefore, the sheet quality resulting from the formation of the fibrous web. More specifically, the forming fabric must simultaneously control the rate of drainage while preventing fiber and other solid components contained in the slurry from passing through the fabric with the water. The role of the forming fabric also includes conveyance of the fibrous web to the press section of the papermaking machine.

Additionally, if drainage of water from the slurry occurs too rapidly or too slowly, the quality of the fibrous web and the overall machine production efficiency are reduced. Controlling drainage by way of fabric void volume is one of the fabric design criteria.

Forming fabrics have been produced to meet the needs and requirements of the various papermaking machines for the various paper grades being manufactured. As the need arises to increase production speed of the papermaking machines and the quality of the paper being produced, the need for improved paper machine clothing allowing for increased production rates and improved quality results.

In tissue making, it is known to add texture or patterns to the fibrous web during manufacturing. In WO 02/088464 it is known to pattern paper for use in a tissue for beverage infusion, for example, a tea bag. Here, a screen, or forming fabric, is used for producing paper by a wet-laying technique. The screen has a base material woven in a mesh-like structure, for example, with synthetic monofilaments. Drainage blockage of the base material is accomplished by applying a synthetic resin to block apertures of the base fabric mesh. The pattern or letters are formed by laying down a polymer that provides complete or partial blockage of discrete apertures. In this manner, the polymer does not affect the surface properties of the woven fabric as the polymer fills discrete apertures of the fabric mesh. A pattern is formed when the water of the fibrous suspension drains through regions of the fabric that are not blocked. The result is a paper product with higher fiber concentration corresponding to unblocked areas as compared to blocked areas. In this manner, a pattern is formed where there is lower fiber concentration. This results in a weakness of the fibrous web in the areas of lower fiber concentration.

While printed forming fabrics can be used on conventional tissue machines, there is no advantage to using them on conventional tissue machines were the sheet is 100% pressed and the bulk is too low to produce micro-embossed and macro-embossed sheets in the machine and a converting line to emboss the sheet is needed. The printed forming fabric can be used on through air drying machines (TAD) where the bulk and sheet absorbency is 50 to 100% higher than on conventional machines. On this kind of machine, the sheet is formed on a twin wire and is vacuum dewatered to a dryness between 22% and 26%. Only at this high consistency, the sheet is transferred to a structured fabric where it is wet molded by a vacuum box (wet shaping box), which suctions the fibers into the valleys of the structured fabric. By suctioning an already formed sheet, with over 20% consistency, the fibers are stretched into the valleys, thus the sheet caliper is reduced and only a small portion of the fibers remain protected within the structure of the fabric, these being the fibers which will be remain unpressed for quality. Thus, on TAD machines, there is a need to run a negative draw between the forming section and the TAD section. Generally, TAD machines run at 20% lower speed on the TAD section to brush the fibers into the valleys of the fabric. In this manner, all the macro embossing (drawings) coming from the printed forming fabric will be destroyed by the speed difference between the forming section and the TAD section. Accordingly, on TAD machines the macro and micro-embossing has to be done with the structured fabric in the TAD section and not in the forming section. By doing this micro and macro embossing in the machine it would be possible to avoid doing it in the converting line, thus compacting the sheet and loosing quality.

What is needed in the art is a fabric that forms a web having texture and more uniform fiber concentrations for improved marking and overall performance.

### SUMMARY OF THE INVENTION

The present invention provides a fabric used in papermaking, and more particularly, a forming fabric for manufacturing a web for tissue in an advanced dewatering system. In an embodiment, the fabric is a forming fabric having a polymeric deposit. The fabric may be any known forming fabric, for example, single or multi-layer.

Additionally, the present invention provides a forming fabric that produces a structured sheet in the Advanced Dewatering System (ADS, also known as Advanced Tissue Molding System, or ATMOS) machine, which produces the same quality, bulk and water absorbency as TAD machines and does the micro-embossing with the structured fabric and the macro-embossing with the special developed forming fabric. Since the produced sheet is already wet structured in the machine, there is no need to further emboss the sheet going through an expensive converting line to press the micro and macro structures into the sheet. By pressing the structure into the dry sheet on a converting line, the sheet is compacted, thus the quality, bulk, volume and absorbency capacity are reduced. In ATMOS, the speed of the paper stays approximately the same during fabric transfer.

On an ADS, the sheet is formed and dewatered between the structured fabric and a forming fabric, and the sheet is further dewatered between the structured fabric and a dewatering fabric. The sheet is dewatered through the dewatering fabric (opposite to structured fabric) and the dewatering is done by an air flow and a mechanical pressure field. The mechanical pressure field is generated by a permeable belt. The direction of the air flow is from the permeable belt to the dewatering fabric. This sandwich of fabrics forms an extended pressure nip over a vacuum roll. The max peak pressure is approximately 40 times lower than a conventional press and there is air flow through the nip. The sheet is protected and further carried by the structured fabric to the Yankee dryer and is further dried by Yankee/Hood and dry creped. Accordingly, a structured sheet like a TAD product is produced with the same premium quality, but without using the expensive TAD machine. There is 40% less capital investment, less machine equipment, less civil work, simplified building, easier operation, less maintenance and 35% less total consumable cost (energy, clothing, chemicals).

Another advantage of this solution is that the sheet is formed over a structured fabric, starting with very low consistency, between about 0.15% to 0.35%, and the same structured fabric carries the fibers, protected within its structure, from the headbox to the transfer to the Yankee dryer. Against the Yankee dryer, only the fibers at the knuckle area of the structured fabric will be pressed, and the protected fibers, within the body of the structured fabric, remain unpressed for quality. The valleys of the structured fabric are filled with the maximum amount of fibers because this will be the mass of unpressed fibers which will give the final premium paper quality.

Since the produced sheet is already structured, there is no need to further emboss the sheet going through an expensive converting line to press the micro and macro structures into the sheet. By pressing the structure into the dry sheet in a converting line, the sheet is compacted, thus, the quality, bulk, volume and absorbency capacity is reduced.

Still further, the fabric is, for example, made from, but are not limited to mono filament yarns, synthetic or polyester mono filament yarns, twisted mono filament yarns, twisted synthetic or twisted polyester or twisted polyamide mono filament yarns, twisted multi-filament yarns, twisted synthetic or twisted polyester multi-filament yarns, core and sheath, non-plastic materials, co-polymer materials, and others. Various yarn profiles can be employed including, for example, yarns having a circular cross sectional shape with one or more diameters or other cross sectional shapes, for example, non-round cross sectional shapes such as oval, or a polygonal cross sectional shapes, for example diamond, square, pentagonal, hexagonal, septagonal, octagonal, and so forth, or any other shape that the yarns may be fabricated.

Materials used to make the base fabric can be from, for example, polyethylenepterathalate (PET), polyamides (PA), polyethylene naphthalate (PEN), polybutylene tere-phthalate (PBT) and polyetheretherketone (PEEK). Likewise, the fabric can be made from one or more materials.

The polymeric material to be deposited is at least one of a silicone and a polyurethane. By way of example, the silicone can be any RTY-type, two-component heat curable material. Other possible polymeric materials, selectable based on the application, include, but are not limited to, acrylics, epoxy resins, silicones, polyurethanes—such as thermoplastic, thermoset, and two component polyurethanes, hydrosols, polyolefins—such as ABS, PS, PC, PET, PPS, PEEK, PA, EVA, PE, HDPE, LDPE, LLDPE, PP, PTFE, and PVC, UV curables, rubbers—both natural and synthetic, nanopolymers/technology, carbon fullerenes, dendrimers, polymers loaded with carbon or metals, electrically conducting polymers and semi-conductors, liquid crystal polymers, hot melts, polymers that are sensitive to pressure, light and temperature, reactive polymers and living polymers. When cured, the polymeric material has a shore A hardness of approximately 3 to approximately 80, depending on the material used and the predetermined application.

The polymer material added to the fabric can be deposited in a random pattern, a pseudo-random pattern, a predetermined pattern, or any combination of the three to form a pattern or motif on the final tissue paper.

In an embodiment, the polymeric material is delivered to the fabric either through a screen or from a bank of small bore tubes (needle application) set at a predetermined distance above the fabric. When the screen method is used, the polymeric material is delivered through the screen by a blade that is in contact with the inside face of the screen. In this manner the print height is determined by the thickness of the screen wall.

For the screen application, to control the flow of the polymeric material into the fabric, the viscosity of the polymeric material is less than 40,000 centipoises cP. For small bore needle applications, the viscosity of the polymeric material is less than 50,000 centipoises cP. The viscosity of the polymeric material is selected to control the amount of penetration of the polymeric material into the fabric. For the present invention, penetration is between about 10% and about 100%. The amount of penetration into the fabric is a function of the fabric and the use of the fabric. For general applications, the penetration is, for example, approximately 40%-60%. When a fine mesh fabric is used, the penetration can be, for example, up to 100%.

The height of the polymeric material above the surface of the paper side of the fabric is variable depending on the method of application and the desires of the application. For example, when screening the polymeric material onto the fabric, the polymer material has a height above the surface of the fabric of about 0.01 mm to about 1.0 mm, for example, about 0.05 mm. When used for embossing type applications, for example, through air drying (TAD), the height above the surface of the fabric is about 0.1 mm to about 2.0 mm, for example, about 0.1 mm to about 1.0 mm, or about 0.05 mm. For small bore needle applications, the height of the polymeric material can be up to 3 mm. Permeability range of the fabric with the applied pattern/design is approximately 50 cfm to approximately 1200 cfm, for example, in the range of approximately 200 cfm to approximately 900 cfm, or approximately 300 cfm to approximately 800 cfm. It is also understood that there are no limitations to the paper grades or former types where the present invention can be applied.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a cross-sectional schematic diagram illustrating the formation of a structured web using an embodiment of a method of the present invention;

FIG. 2 is a cross-sectional view of a portion of a structured web of a prior art method;

FIG. 3 is a cross-sectional view of a portion of the structured web of an embodiment of the present invention as made on the machine of FIG. 1;

FIG. 4 illustrates the web portion of FIG. 2 having subsequently gone through a press drying operation;

FIG. 5 illustrates a portion of the fiber web of the present invention of FIG. 3 having subsequently gone through a press drying operation;

FIG. 6 illustrates a resulting fiber web of the forming section of the present invention;

FIG. 7 illustrates the resulting fiber web of the forming section of a prior art method;

FIG. 8 illustrates the moisture removal of the fiber web of the present invention;

FIG. 9 illustrates the moisture removal of the fiber web of a prior art structured web;

FIG. 10 illustrates the pressing points on a fiber web of the present invention;

FIG. 11 illustrates pressing points of prior art structured web;

FIG. 12 illustrates a schematical cross-sectional view of an embodiment of a papermaking machine of the present invention;

FIG. 13 illustrates a schematical cross-sectional view of another embodiment of a papermaking machine of the present invention;

FIG. 14 illustrates a schematical cross-sectional view of another embodiment of a papermaking machine of the present invention;

FIG. 15 illustrates a schematical cross-sectional view of another embodiment of a papermaking machine of the present invention;

FIG. 16 illustrates a schematical cross-sectional view of another embodiment of a papermaking machine of the present invention;

FIG. 17 illustrates a schematical cross-sectional view of another embodiment of a papermaking machine of the present invention; and

FIG. 18 illustrates a schematical cross-sectional view of another embodiment of a papermaking machine of the present invention;

FIG. 19 is a perspective view of a forming fabric with an extended surface according to the present invention;

FIG. 20 is a top view of a forming fabric with an extended surface according to the present invention; and

FIG. 21 is a cross-section along A-A of the forming fabric of FIG. 20.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

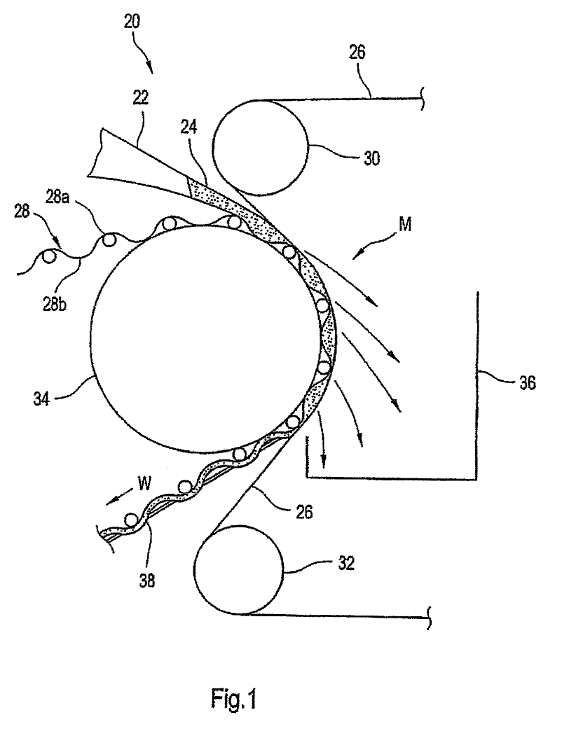

Referring now to the drawings, and more particularly to FIG. 1, there is shown fibrous web machine 20 including headbox 22 that discharges fibrous slurry 24 between forming fabric 26 and structured fabric 28. Rollers 30 and 32 direct fabric 26 in such a manner that tension is applied against slurry 24 and structured fabric 28. Structured fabric 28 is supported by forming roll 34 which rotates with a surface speed that matches the speed of structured fabric 28 and forming fabric 26. Structured fabric 28 has peaks 28a and valleys 28b, which give a corresponding structure to web 38 formed thereon. Structured fabric 28 travels in direction W and, as moisture M is driven from fibrous slurry 24, structured fibrous web 38 takes form. Moisture M that leaves slurry 24 travels through forming fabric 26 and is collected in save-all 36. Fibers in fibrous slurry 24 collect predominately in valleys 28b as web 38 takes form.

Structured fabric 28 includes warp and weft yarns interwoven on a textile loom. Structured fabric 28 may be woven flat or in an endless form. The final mesh count of structured fabric 28 lies between 95×120 and 26×20. For the manufacture of toilet tissue, for example, the mesh count may be 51×36 or higher or, for example, 58×44 or higher. For the manufacturer of paper towels, for example, the mesh count may be 42×31 or lower, or, for example, 36×30 or lower. Structured fabric 28 may have a repeated pattern of 4 shed and above repeats or, for example, 5 shed or greater repeats. The warp yarns of structured fabric 28 have diameters of between 0.12 mm and 0.70 mm, and weft yarns have diameters of between 0.15 mm and 0.60 mm. The pocket depth, which is the offset between peak 28a and valley 28b, is between approximately 0.07 mm and 0.60 mm. Yarns utilized in structured fabric 28 may be of any cross-sectional shape, for example, round, oval or flat. The yarns of structured fabric 28 can be made of thermaplastic or thermaset polymeric materials of any color. The surface of structured fabric 28 can be treated to provide a desired surface energy, thermal resistance, abrasion resistance and/or hydrolysis resistance. A printed design, such as a screen printed design, of polymeric material can be applied to structured fabric 28 to enhance its ability to impart an aesthetic pattern into web 38 or to enhance the quality of web 38. Such a design may be in the form of an elastomeric cast structure similar to the Spectra® membrane described in another patent application. Structured fabric 28 has a top surface plane contact area at peak 28a of 10% or higher, for example, 20% or higher, or 30% depending upon the particular product being made. The contact area on structured web 28 at peak 28a can be increased by abrading the top surface of structured fabric 28 or an elastomeric cast structure can be formed thereon having a flat top surface. The top surface may also be hot calendered to increase the flatness.

Forming roll 34 is preferably solid. Moisture travels through forming fiber 26, but not through structured fabric 28. This advantageously forms structured fibrous web 38 into a more bulky or absorbent web than the prior art.

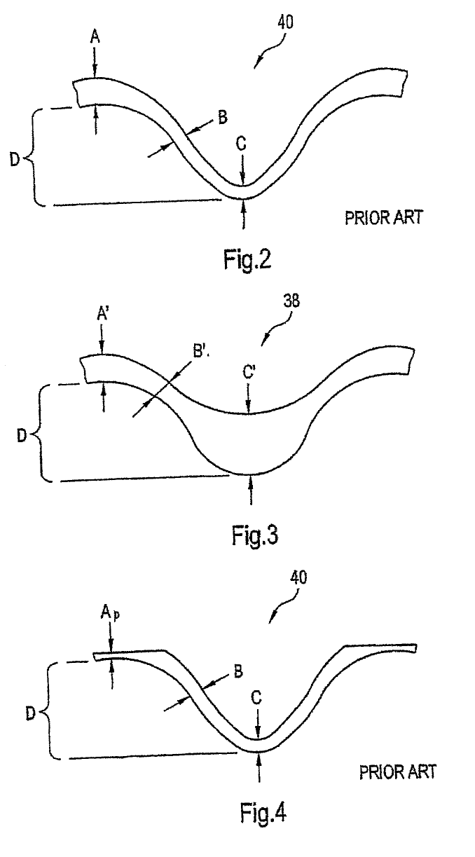

Prior art methods of moisture removal remove moisture through a structured fabric by way of negative pressure. It results in a cross-sectional view as seen in FIG. 2. Prior art structured web 40 has pocket depth D which corresponds to the dimensional difference between a valley and a peak, the valley occurring at the point where measurement C occurs and the peak occurring at the point where measurement A is taken. Top surface thickness A is formed in the prior art method. Sidewall dimension B and pillow thickness C of the prior art result from moisture drawn through a structured fabric. Dimension B is less than dimension A and dimension C is less than dimension B in the prior art structure.

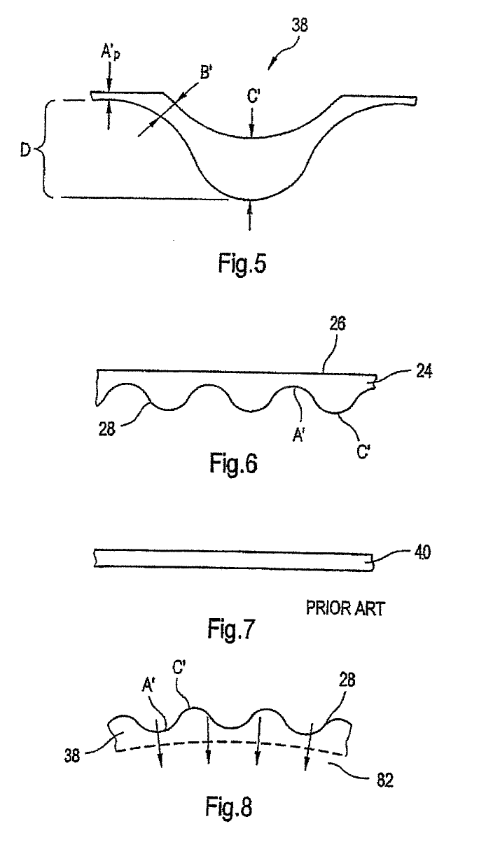

In contrast, structured web 38, as illustrated in FIGS. 3 and 5, have, for discussion purposes, pocket depth D that is similar to the prior art. However, sidewall thickness B′ and pillow thickness C′ exceed the comparable dimensions of web 40. This advantageously results from the forming of structural web 38 on structured fabric 28 at low consistency and the removal of moisture in an opposite direction from the prior art. This results in thicker pillow dimension C′. Even after fiber web 38 goes through a drying press operation, as illustrated in FIG. 5, dimension C′ is substantially greater than A′p. Advantageously, the fiber web resulting from the present invention has a higher basis weight in the pillow areas as compared to prior art. Also, the fiber to fiber bonds are not broken as they can be in impression operations, which expand the web into the valleys.

According to prior art, an already formed web is vacuum transferred into a structured fabric. The sheet must then expand to fill the contour of the structured fabric. In doing so, fibers must move apart. Thus, the basis weight is lower in these pillow areas and, therefore, the thickness is less than the sheet at point A.

Now, referring to FIGS. 6 to 11, the process will be explained by simplified schematic drawings.

As shown in FIG. 6, fibrous slurry 24 is formed into web 38 with a structure inherent in the shape of structured fabric 28. Forming fabric 26 is porous and allows moisture to escape during forming. Further, water is removed as shown in FIG. 8, through dewatering fabric 82. The removal of moisture through fabric 82 does not cause a compression of pillow areas C′ in the forming web, since pillow areas C′ reside in the structure of structured fabric 28.

Prior art web 40, shown in FIG. 7, is formed with a conventional forming fabric, as between two conventional forming fabrics in a twin wire former, and is characterized by a flat uniform surface. It is this fiber web that is given a three-dimensional structure by a wet shaping stage, which results in the fiber web shown in FIG. 2. A conventional tissue machine that employs a conventional press fabric will have a contact area approaching 100%. Normal contact area of the structured fiber, as in the present invention or on a TAD machine is typically much lower than that of a conventional machine. It is in the range of 15% to 35%, depending on the particular pattern of the product being made.

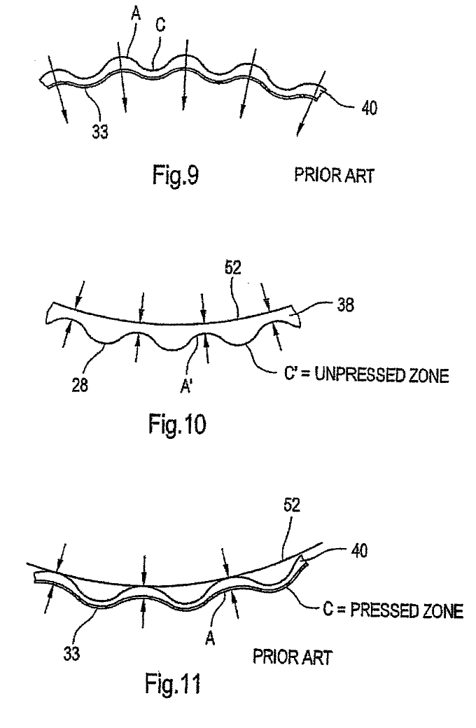

In FIGS. 9 and 11 a prior art web structure is shown where moisture is drawn through structured fabric 33 causing the web, as shown in FIG. 7, to be shaped and causing pillow area C to have a low basis weight as the fibers in the web are drawn into the structure. The shaping can be done by performing pressure or underpressure to web 40 forcing web 40 to follow the structure of structured fabric 33. This additionally causes fiber tearing as they are moved into pillow area C. Subsequent pressing at Yankee dryer 52, as shown in FIG. 11, further reduces the basis weight in area C. In contrast, water is drawn through dewatering fabric 82 in the present invention, as shown in FIG. 8, preserving pillow areas C′. Pillow areas C′ of FIG. 10, are unpressed zones, which are supported on structured fabric 28, while pressed against Yankee 52. Pressed zone A′ is the area through which most of the pressure applied is transferred. Pillow area C′ has a higher basis weight than that of the illustrated prior art structures.

The increased mass ratio of the present invention, particularly the higher basis weight in the pillow areas, carries more water than the compressed areas, resulting in at least two positive aspects of the present invention over the prior art, as illustrated in FIGS. 10 and 11. First, it allows for a good transfer of the web to Yankee surface 52 since the web has a relatively lower basis weight in the portion that comes in contact with Yankee surface 52 at a lower overall sheet solid content than had been previously attainable because of the lower mass of fibers that comes in contact with Yankee dryer 52. The lower basis weight means that less water is carried to the contact points with Yankee dryer 52. The compressed areas are dryer than the pillow areas, thereby allowing an overall transfer of the web to another surface, such as Yankee dryer 52, with a lower overall web solids content. Secondly, the construct allows for the use of higher temperatures in Yankee hood 54 without scorching or burning of the pillow areas, which occurs in the prior art pillow areas. Yankee hood 54 temperatures are often greater than 350° C. and may, for example, be greater than 450° C. or even greater than 550° C. As a result, the present invention can operate at lower average pre-Yankee press solids than the prior art, making more full use of the capacity of the Yankee Hood drying system. The present invention allows the solids content of web 38 prior to the Yankee dryer to run at less than 40%, for example, less than 35% and even as low as 25%.

Due to the formation of the web 38 with structured fabric 28 the pockets of fabric 28 are fully filled with fibers. Therefore, at Yankee surface 52 web 38 has a much higher contact area, up to approx. 100%, as compared to the prior art because web 38 on the side contacting Yankee surface 52 is almost flat. At the same time pillow areas C′ of web 38 maintain unpressed, because they are protected by the valleys of structured fabric 28 (FIG. 10). Good results in drying efficiency were obtained only pressing 25% of the web.

As can be seen in FIG. 11, the contact area of prior art web 40 to Yankee surface 52 is much lower as compared to the one of web 38 manufactured according to the present invention. The lower contact area of prior art web 40 results from the shaping of web 40 that now follows the structure of structured fabric 33. Due to less contact area of prior art web 40 to Yankee surface 52, the drying efficiency is less.

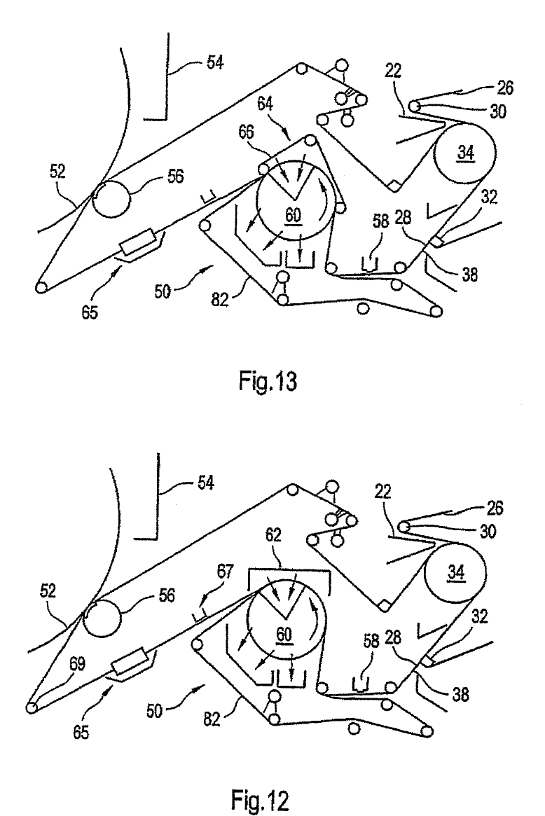

Now, referring to FIG. 12, there is shown an embodiment of the process where structured fiber web 38 is formed. Structured fabric 28 carries three dimensional structured web 38 to advanced dewatering system 50, past suction box 67 and then to Yankee roll 52 where the web is transferred to Yankee roll 52 and hood section 54 for additional drying and creping before winding up on a reel (not shown). Shoe press 56 is placed adjacent to structured fabric 28, holding it in a position proximate to Yankee roll 52. Structured web 38 comes into contact with Yankee roll 52 and transfers to a surface thereof, for further drying and subsequent creping. Vacuum box 58 is placed adjacent to structured fabric 28 to achieve a solids level of 15-25% on a nominal 20 gsm web running at −0.2 to −0.8 bar vacuum, for example, with an operating level of −0.4 to −0.6 bar. Web 38, which is carried by structured fabric 28, contacts dewatering fabric 82 and proceeds toward vacuum roll 60. Vacuum roll 60 operates at a vacuum level of −0.2 to −0.8 bar, for example, with an operating level of at least −0.4 bar. Hot air hood 62 is optionally fit over vacuum roll 60 to improve dewatering. If, for example, a commercial Yankee drying cylinder with 44 mm steel thickness and a conventional hood with an air blowing speed of 145 m/s is used, production speeds of 1400 m/min or more for towel paper and 1700 m/min or more for toilet paper are used.

Optionally, a steam box can be installed instead of hood 62 supplying steam to web 38. The steam box may have a sectionalized design to influence the moisture re-dryness cross profile of web 38. The length of the vacuum zone inside vacuum roll 60 can be from 200 mm to 2,500 mm, for example, 300 mm to 1,200 mm, or a length of between 400 mm to 800 mm. The solids level of web 38 leaving suction roll 60 is 25% to 55% depending on installed options. Vacuum box 67 and hot air supply 65 can be used to increase web 38 solids after vacuum roll 60 and prior to Yankee roll 52. Wire turning roll 69 can also be a suction roll with a hot air supply hood. Roll 56 includes a shoe press with a shoe width of 80 mm or more, for example, 120 mm or more, with a maximum peak pressure of less than 2.5 MPa. To create an even longer nip to facilitate the transfer of web 38 to Yankee 52, web 38 carried on structured fabric 28 can be brought into contact with the surface of Yankee roll 52 prior to the press nip associated with shoe press 56. Further, the contact can be maintained after structured fabric 28 travels beyond press 56.

Dewatering fabric 82 may have a permeable woven base fabric connected to a batt layer. The base fabric includes machine direction yarns and cross-directional yarns. The machine direction yarn is a 3 ply multifilament twisted yarn. The cross-direction yarn is a monofilament yarn. The machine direction yarn can also be a monofilament yarn and the construction can be of a typical multilayer design. In either case, the base fabric is needled with a fine batt fiber having a weight of less than or equal to 700 gsm, for example, less than or equal to 150 gsm, or less than or equal to 135 gsm. The batt fiber encapsulates the base structure giving it sufficient stability. The needling process can be such that straight through channels are created. The sheet contacting surface is heated to improve its surface smoothness. The cross-sectional area of the machine direction yarns is larger than the cross-sectional area of the cross-direction yarns. The machine direction yarn is a multifilament yarn that may include thousands of fibers. The base fabric is connected to a batt layer by a needling process that results in straight through drainage channels.

In another embodiment of dewatering fabric 82 there is included a fabric layer, at least two batt layers, an anti-rewetting layer and an adhesive. The base fabric is substantially similar to the previous description. At least one of the batt layers includes a low melt bi-compound fiber to supplement fiber to fiber bonding upon heating. On one side of the base fabric, there is attached an anti-rewetting layer, which may be attached to the base fabric by an adhesive, a melting process or needling wherein the material contained in the anti-rewetting layer is connected to the base fabric layer and a batt layer. The anti-rewetting layer is made of an elastomeric material, thereby forming an elastomeric membrane, which has openings therethrough. The batt layers are needled to hold dewatering fabric 82 together. This advantageously leaves the batt layers with many needled holes therethrough. The anti-rewetting layer is porous having water channels or straight through pores therethrough.

In another embodiment of dewatering fabric 82, there is a construct substantially similar to that previously discussed with the addition of a hydrophobic layer to at least one side of de-watering fabric 82. The hydrophobic layer does not absorb water, but it does direct water through pores therein.

In another embodiment of dewatering fabric 82, the base fabric has attached thereto a lattice grid made of a polymer, such as polyurethane, that is put on top of the base fabric. The grid may be put on the base fabric by utilizing various known procedures, such as, for example, an extrusion technique or a screen-printing technique. The lattice grid may be put on the base fabric with an angular orientation relative to the machine direction yarns and the cross direction yarns. Although this orientation is such that no part of the lattice is aligned with the machine direction yarns, other orientations can also be utilized. The lattice can have a uniform grid pattern, which can be discontinuous in part. Further, the material between the interconnections of the lattice structure may take a circuitous path rather than being substantially straight. The lattice grid is made of a synthetic, such as a polymer or a polyurethane, which attaches itself to the base fabric by its natural adhesion properties.

In another embodiment of dewatering fabric 82, there is included a permeable base fabric having machine direction yarns and cross-direction yarns that are adhered to a grid. The grid is made of a composite material the may be the same as that discussed relative to a previous embodiment of dewatering fabric 82. The grid includes machine direction yarns with a composite material formed therearound. The grid is a composite structure formed of composite material and machine direction yarns. The machine direction yarns may be pre-coated with a composite before being placed in rows that are substantially parallel in a mold that is used to reheat the composite material causing it to re-flow into a pattern. Additional composite material may be put into the mold as well. The grid structure, also known as a composite layer, is then connected to the base fabric by one of many techniques including laminating the grid to the permeable fabric, melting the composite coated yarn as it is held in position against the permeable fabric or by re-melting the grid onto the base fabric. Additionally, an adhesive may be utilized to attach the grid to permeable fabric.

The batt fiber may include two layers, an upper and a lower layer. The batt fiber is needled into the base fabric and the composite layer, thereby forming dewatering fabric 82 having at least one outer batt layer surface. Batt material is porous by its nature, additionally the needling process not only connects the layers together, it also creates numerous small porous cavities extending into or completely through the structure of dewatering fabric 82.

Dewatering fabric 82 has an air permeability of from approximately 5 to approximately 100 cubic feet/minute, for example, 19 cubic feet/minute or higher or 35 cubic feet/minute or higher. Mean pore diameters in dewatering fabric 82 are from approximately 5 to approximately 75 microns, for example, 25 microns or higher or, 35 microns or higher. The hydrophobic layers can be made from a synthetic polymeric material, a wool or a polyamide, for example, nylon 6. The anti-rewet layer and the composite layer may be made of a thin elastomeric permeable membrane made from a synthetic polymeric material or a polyamide that is laminated to the base fabric.

The batt fiber layers are made from fibers ranging from 0.5 d-tex to 22 d-tex and may contain a low melt bi-compound fiber to supplement fiber to fiber bonding in each of the layers upon heating. The bonding may result from the use of a low temperature meltable fiber, particles and/or resin. The dewatering fabric can be less than 2.0 millimeters, for example, less than 1.50 millimeters, less than 1.25 millimeters or less than 1.0 millimeter thick. Embodiments of dewatering fabric 82 are also described in the PCT/EP2004/053688 and PCT/EP2005/050198 which are herewith incorporated by reference.

Now, referring to FIG. 13, there is shown another embodiment of the present invention which is substantially similar to the embodiment illustrated in FIG. 12 except that instead of hot air hood 62 there is belt press 64. Belt press 64 includes permeable belt 66 capable of applying pressure to the non-sheet contacting side of structured fabric 28 that carries web 38 around suction roll 60. Fabric 66 of belt press 64 is also known as an extended nip press belt or a link fabric, which can run at 60 KN/m fabric tension with a pressing length that is longer than the suction zone of roll 60. Embodiments of fabric 66 and the required operation conciliation are also described in PCT/EP2004/053688 and PCT/EP2005/050198 which are herewith incorporated by reference. The above mentioned references are also fully applicable for dewatering fabrics 82 and press fabrics 66 d described in the further embodiments. While pressure is applied to structured fabric 28, the high fiber density pillow areas in web 38 are protected from that pressure as they are contained within the body of structured fabric 28, as they are in the Yankee nip. Belt 66 is a specially designed Extended Nip Press Belt 66, made of, for example reinforced polyurethane and/or a spiral link fabric. Belt 66 is permeable thereby allowing air to flow therethrough to enhance the moisture removing capability of belt press 64. Moisture is drawn from web 38 through dewatering fabric 82 and into vacuum roll 60.

Belt 66 provides a low level of pressing in the range of 50-300 KPa, for example, greater than 100 KPa. This allows a suction roll with a 1.2 meter diameter to have a fabric tension of greater than 30 KN/m, for example, greater than 60 KN/m. The pressing length of permeable belt 66 against fabric 28, which is indirectly supported by vacuum roll 60, is at least as long as a suction zone in roll 60. Although the contact portion of belt 66 can be shorter than the suction zone.

Permeable belt 66 has a pattern of holes therethrough, which may, for example, be drilled, laser cut, etched formed or woven therein. Permeable belt 66 may be monoplanar without grooves. In one embodiment, the surface of belt 66 has grooves and is placed in contact with fabric 28 along a portion of the travel of permeable belt 66 in belt press 64. Each groove connects with a set of the holes to allow the passage and distribution of air in belt 66. Air is distributed along the grooves, which constitutes an open area adjacent to contact areas, where the surface of belt 66 applies pressure against web 38. Air enters permeable belt 66 through the holes and then migrates along the grooves, passing through fabric 28, web 38 and fabric 82. The diameter of the holes may be larger than the width of the grooves. The grooves may have a cross-section contour that is generally rectangular, triangular, trapezoidal, semi-circular or semi-elliptical. The combination of permeable belt 66 associated with vacuum roll 60 is a combination that has been shown to increase sheet solids by at least 15%.

An example of another structure of belt 66 is that of a thin spiral link fabric, which can be a reinforcing structure within belt 66 or the spiral link fabric will itself serve as belt 66. Within fabric 28 there is a three dimensional structure that is reflected in web 38. Web 38 has thicker pillow areas, which are protected during pressing as they are within the body of structured fabric 28. As such the pressing imparted by belt press assembly 64 upon web 38 does not negatively impact web quality, while it increases the dewatering rate of vacuum roll 60.

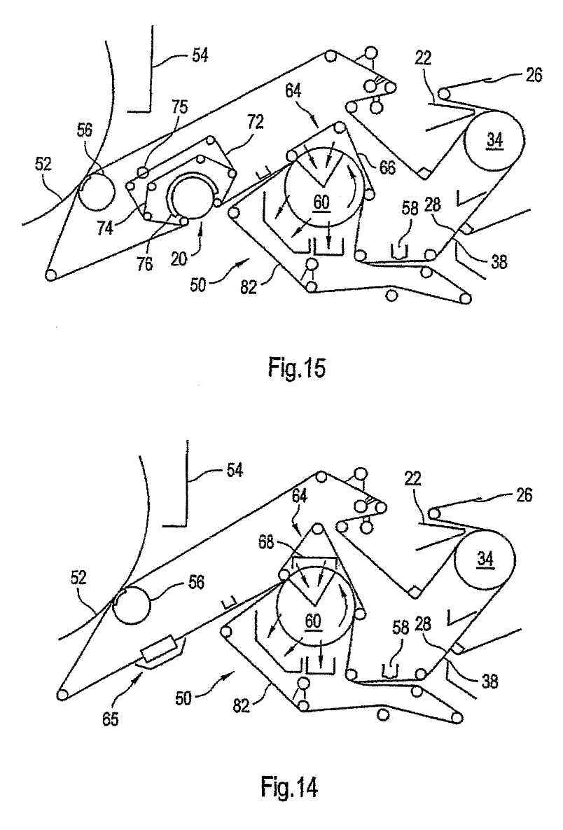

Referring now to FIG. 14, which is similar to the embodiment shown in FIG. 13, including hot air hood 68 placed inside of belt press 64 to enhance the dewatering capability of belt press 64 in conjunction with vacuum roll 60.

Referring now to FIG. 15, there is shown another embodiment of the present invention, which is similar to the embodiment shown in FIG. 13, but including boost dryer 70, which encounters structured fabric 28. Web 38 is subjected to a hot surface of boost driver 70. Structure web 38 rides around boost driver 70 with another woven fabric 72 riding on top of structured fabric 28. On top of woven fabric 72 is thermally conductive fabric 74, which is in contact with both woven fabric 72 and cooling jacket 76 that applies cooling and pressure to all fabrics and web 38. Here again, the higher fiber density pillow areas in web 38 are protected from the pressure as they are contained within the body of structured fabric 28. As such, the pressing process does not negatively impact web quality. The drying rate of boost dryer 70 is greater than 400 kg/hrm2, for example, greater than 500 kg/hrm2. The concept of boost dryer 70 is to provide sufficient pressure to hold web 38 against the hot surface of the dryer thus preventing blistering. Steam that is formed at the knuckle points of fabric 28 passes through fabric 28 and is condensed on fabric 72. Fabric 72 is cooled by fabric 74 that is in contact with the cooling jacket, which reduces its temperature to well below that of the steam. Thus the steam is condensed to avoid a pressure build up to thereby avoid blistering of web 38. The condensed water is captured in woven fabric 72, which is dewatered by dewatering device 75. It has been shown that depending on the size of boost dryer 70, the need for vacuum roll 60 can be eliminated. Further, depending upon the size of boost dryer 70, web 38 may be creped on the surface of boost dryer 70, thereby eliminating the need for Yankee dryer 52.

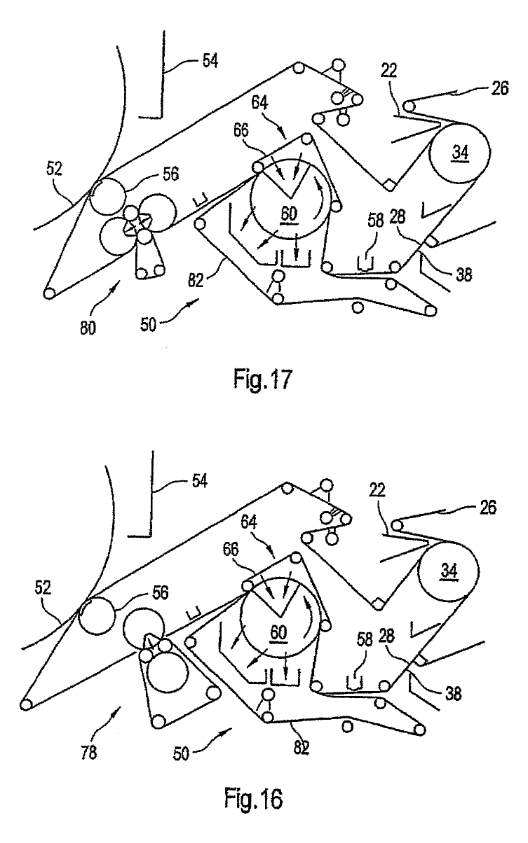

Referring now to FIG. 16, there is shown another embodiment of the present invention similar to the invention disclosed in FIG. 13, but with an addition of air press 78 which is a four roll cluster press that is used with high temperature air and is referred to as an HPTAD for additional web drying prior to the transfer of web 38 to Yankee 52. Four roll cluster press 78 includes a main roll and a vented roll and two cap rolls. The purpose of this cluster press is to provide a sealed chamber that is capable of being pressurized. The pressure chamber contains high temperature air, for example, 150° C. or higher, and is at a significantly higher pressure than conventional TAD technology, for example, greater than 1.5 psi resulting in a much higher drying rate than a conventional TAD. The high pressure hot air passes through an optional air dispersion fabric, through web 38 and fabric 28 into a vent roll. The air dispersion fabric may prevent web 38 from following one of the four cap rolls. The air dispersion fabric is very open, having a permeability that equals or exceeds that of fabric 28. The drying rate of the HPTAD depends on the solids content of web 38 as it enters the HPTAD. The drying rate may be at least 500 kg/hr/m2, which is a rate of at least twice that of conventional TAD machines.

Advantages of the HPTAD process are in the areas of improved sheet dewatering without a significant loss in sheet quality, compactness in size and energy efficiency. Additionally, it enables higher pre-Yankee solids, which increase the speed potential of the present invention. Further, the compact size of the HPTAD allows for easy retrofit to an existing machine. The compact size of the HPTAD and the fact that it is a closed system means that it can be easily insulated and optimized as a unit to increase energy efficiency.

Referring now to FIG. 17, there is shown another embodiment of the present invention. This is similar to FIGS. 13 and 16 except for the addition of two-pass HPTAD 80. In this case, two vented rolls are used to double the dwell time of structured web 38 relative to the design shown in FIG. 16. An optional coarse mesh fabric may be used as in the previous embodiment. Hot pressurized air passes through web 38 carried on fabric 28 and onto the two vent rolls. It has been shown that, depending on the configuration and size of the HPTAD, more than one HPTAD can be placed in series, which can eliminate the need for roll 60.

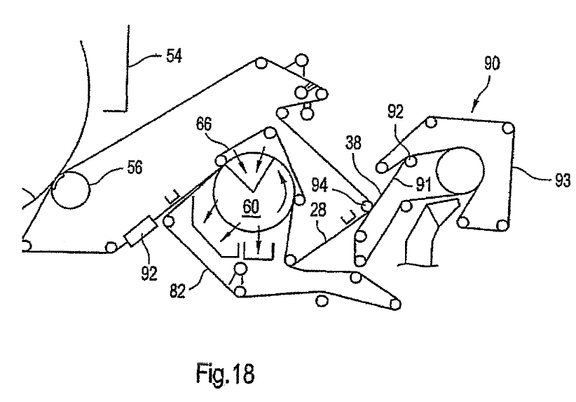

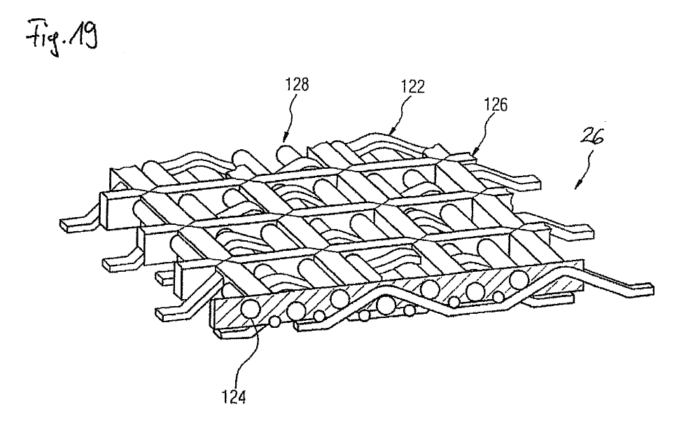

Referring now to FIG. 18, conventional Twin Wire Former 90 may be used to replace the Crescent Former shown in previous examples. The forming roll can be either a solid or open roll. If an open roll is used, care must be taken to prevent significant dewatering through the structured fabric to avoid losing basis weight in the pillow areas. Outer forming fabric 93 can be either a standard forming fabric or one such as that disclosed in U.S. Pat. No. 6,237,644. Inner forming fabric 91 must be structured fabric 91 that is much coarser than the outer forming fabric. Vacuum box 92 may be needed to ensure that the web stays with structured wire 91 and does not go with outer wire 90. Web 38 is transferred to structured fabric 28 using a vacuum device. The transfer can be a stationary vacuum shoe or vacuum assisted rotating pick-up roll 94. Second structured fabric 28 is at least the same coarseness and may be courser than first structured fabric 91. The process from this point is the same as one of the previously discussed processes. The registration of the web from the first structured fabric to the second structured fabric is not perfect, as such some pillows will lose some basis weight during the expansion process, thereby losing some of the benefit of the present invention. However, this process option allows for running a differential speed transfer, which has been shown to improve some sheet properties. Any of the arrangements for removing water discussed above may be used with the Twin Wire Former arrangement and a conventional TAD.

The fiber distribution of web 38 in the present invention is opposite that of the prior art, which is a result of removing moisture through the forming fabric and not through the structured fabric. The low density pillow areas are of relatively higher basis weight than the surrounding compressed zones, which is opposite of conventional TAD paper. This allows a high percentage of the fibers to remain uncompressed during the process. The sheet absorbency capacity, as measured by the basket method, for a nominal 20 gsm web is equal to or greater than 12 grams water per gram of fiber and often exceeds 15 grams of water per gram fiber. The sheet bulk is equal to or greater than 10 cm3/gm, for example, greater than 13 cm3/gm. The sheet bulk of toilet tissue is expected to be equal to or greater than 13 cm3/gm before calendering.

With the basket method of measuring absorbency, five (5) grams of paper are placed into a basket. The basket containing the paper is then weighted and introduced into a small vessel of water at 20° C. for 60 seconds. After 60 seconds of soak time, the basket is removed from the water and allowed to drain for 60 seconds and then weighted again. The weight difference is then divided by the paper weight to yield the grams of water held per gram of fibers being absorbed and held in the paper.

Web 38 is formed from fibrous slurry 24 that headbox 22 discharges between forming fabric 26 and structured fabric 28. Roll 34 rotates and supports fabrics 26 and 28 as web 38 forms. Moisture M flows through fabric 26 and is captured in save all 36. It is the removal of moisture in this manner that serves to allow pillow areas of web 38 to retain a greater basis weight and, therefore, thickness than if the moisture were to be removed through structured fabric 28. Sufficient moisture is removed from web 38 to allow fabric 26 to be removed from web 38 to allow web 38 to proceed to a drying stage. Web 38 retains the pattern of structured fabric 28 and any zonal permeability effects from fabric 26 that may be present.

The present invention can be further modified within the spirit and scope of this disclosure. This application is, therefore, intended to cover any variations, uses, or adaptations of the invention using its general principles. Further, this application is intended to cover such departures from the present disclosure as come within known or customary practice in the art to which this invention pertains and which fall within the limits of the appended claims.

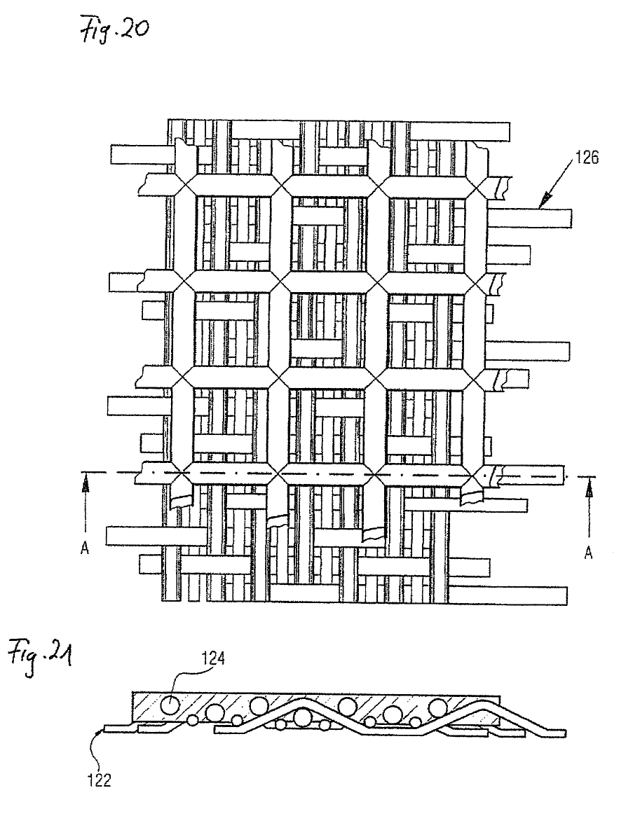

FIGS. 19-22 show forming fabric 26. A series of warp yarns 122 and weft yarns 124 are woven in a predetermined weave pattern. The yarn materials include, but are not limited to mono filament yarns, synthetic or polyester mono filament yarns, twisted mono filament yarns, twisted synthetic or twisted polyester or twisted polyamide mono filament yarns, twisted multi-filament yarns, twisted synthetic or twisted polyester multi-filament yarns, and others. Various yarn profiles can be employed, including, but not limited to, yarns having a circular cross sectional shape with one or more diameters, or other cross sectional shapes, for example, non-round cross sectional shapes such as oval, or a polygonal cross sectional shapes, for example, diamond, square, pentagonal, hexagonal, septagonal, octagonal, and so forth, or any other shape that the yarns may be fabricated into.

Materials used to make the base fabric can be from, but are not limited to, polyethylenepterathalate (PET), polyamides (PA), polyethylene naphthalate (PEN), polybutylene terephthalate (PBT) and polyetheretherketone (PEEK). Likewise, the fabric can be made from one or more materials.

What results is forming fabric 26 having a paper side and a wear side. On the paper side of forming fabric 26, a polymer is applied that forms polymeric lattice 126. The polymeric material to be deposited may be at least one of a silicone and a polyurethane. By way of example, the silicone can be any RTV-type two-component heat curable material. Other possible polymeric materials, selectable based on the application, include, but are not limited to, acrylics, epoxy resins, silicones, polyerethanes—such as thermoplastic, thermoset, and two component polyurethanes, hydrosols, polyolefins—such as ABS, PS, PC, PET, PPS, PEEK, PA, EVA, PE, HDPE, LDPE, LLDPE, PP, PTFE, and PVC, UV curables, rubbers—both natural and synthetic, nanopolymers/technology, carbon fullerenes, dendrimers, polymers loaded with carbon or metals, electrically conducting polymers and semi-conductors, liquid crystal polymers, hot melts, polymers that are sensitive to pressure, light and temperature, reactive polymers and living polymers.

The polymer material added to fabric 26 can be deposited in a random pattern, a pseudo-random pattern, a predetermined pattern, or any combination of the three to form a pattern or motif on the final tissue paper. In an embodiment, the polymeric material is delivered to the fabric either through a screen or from a bank of small bore tubes (needle application) set at the predetermined distance above the fabric 26. When the screen method is used, the polymeric material is delivered through the screen by a blade that is in contact with the inside face of the screen. In this manner the polymer height L above fabric surface 128 is determined by the thickness of the screen wall. For the screen application, to control the flow of the polymeric material into the fabric, the viscosity of the polymeric material is less than 40,000 centipoises cP. For small bore needle applications, the viscosity of the polymeric material is less than 50,000 centipoises cP. The viscosity of the polymeric material is selected to control the amount of penetration of the polymeric material into fabric 26. For the present invention, penetration is between about 10% and about 100%. The amount of penetration into the fabric is a function of the fabric and the use of the fabric. For general applications, the penetration may be approximately 40%-60%. When a fine mesh fabric is used, the penetration can be up to 100%.

Height of the polymeric material L above surface 128 of the paper side of forming fabric 26 is variable depending on the method of application and the desires of the application. For example, when screening the polymeric material onto fabric 26, the polymer material has height L above surface 128 of fabric 26 of about 0.01 mm to about 1.0 mm, for example, about 0.05 mm. When used for embossing type applications, for example, through air drying (TAD), height L above the surface of the fabric is about 0.1 mm to about 2.0 mm, for example, about 0.1 mm to about 1.0 mm, or about 0.05 mm. For small bore needle applications, height L of the polymeric material can be up to 3 mm. Polymeric lattice 126 of an embodiment extends above surface 128 of forming fabric 26 by approximately 0.1 mm.

The polymer material added to fabric 26 can be deposited in a random pattern, a pseudo-random pattern, a predetermined pattern, or any combination of the three to form a pattern or motif on the final tissue paper. That is, rather than a lattice as depicted, the deposition can form a pattern such as a logo, or other non-continuous pattern. Width and length of polymeric lattice 126 can vary, but can range from approximately 0.1 mm to approximately 2 mm, for example, 0.5 mm to 1.0 mm, or 0.75 mm to 1.0 mm.

When cured, the polymeric material has a shore A hardness of approximately 3 to approximately 80, depending on the material used and the predetermined application. Permeability range of the fabric 26 with the applied pattern/design is approximately 50 cfm to approximately 1200 cfm, for example, in the range of approximately 200 cfm to approximately 900 cfm, or approximately 300 cfm to approximately 800 cfm.

While the present invention has been particularly shown and described with reference to the foregoing preferred embodiments, those skilled in the art will understand that many variations may be made therein without departing from the spirit and scope of the invention as defined in the following claims. This description of the present invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A forming fabric for papermaking, comprising:
a woven fabric having a paper side and a roll side, said paper side having a paper side surface and said roll side having a roll side surface; and
a polymer material deposit extending above said paper side surface, said polymer material deposit having at least one of a random pattern, a random motif, a pseudo-random pattern, a pseudo-random motif, a predetermined pattern and a predetermined motif.

2. The forming fabric according to claim 1, wherein said polymer material deposit is one of a lattice structure and a logo.

3. The forming fabric according to claim 1, wherein said polymer material deposit is at least one of an RTY-type material, an RTV-type heat curable material, an acrylic, an epoxy resin, a silicone, a polyurethane, a hydrosol, a polyolefin, UV curable, a natural rubber, a synthetic rubber, nanopolymers, carbon fullerenes, dendrimers, polymers loaded with carbon, polymers loaded with metals, electrically conducting polymers, semi-conductors, liquid crystal polymers, hot melts, polymers that are sensitive to pressure, polymers that are sensitive to light, polymers that are sensitive to temperature, reactive polymers and living polymers.

4. The forming fabric according to claim 3, wherein said polyurethane is at least one of thermoplastic, thermo set and two component polyurethanes.

5. The forming fabric according to claim 3, wherein said polyolefin is at least one of ABS, PS, PC, PET, PPS, PEEK, PA, EVA, PE, HDPE, LDPE, LLDPE, PP, PTFE and PVC.

6. The forming fabric according to claim 1, wherein said polymer material deposit has a shore A hardness of approximately 3 to approximately 80.

7. The forming fabric according to claim 1, wherein said polymeric material deposit is delivered to said woven fabric by at least one of screen printing and from a bank of small bore tubes.

8. The forming fabric according to claim 7, wherein said polymer material deposit has a viscosity of less than approximately 40,000 centipoises and is delivered to said woven fabric by said screen printing.

9. The forming fabric according to claim 1, wherein said polymer material deposit has a viscosity of less than approximately 50,000 centipoises and is delivered to said woven fabric by said small bore needle application.

10. The forming fabric according to claim 1, wherein said polymer material deposit penetrates into said woven fabric at a predetermined amount.

11. The forming fabric according to claim 10, wherein said polymer material deposit penetrates into said woven fabric between approximately 10% and approximately 100%.

12. The forming fabric according to claim 11, wherein said polymer material deposit penetrates into said woven fabric between approximately 40% and approximately 60%.

13. The forming fabric according to claim 1, wherein said woven fabric is a fine mesh fabric.

14. The forming fabric according to claim 13, wherein said polymer material deposit penetrates into said woven fabric up to approximately 100%.

15. The forming fabric according to claim 1, wherein said polymer material deposit has a height above said paper side surface, said height being between approximately 0.01 mm to approximately 3.0 mm.

16. The forming fabric according to claim 15, wherein said height is between approximately 0.01 mm and approximately 1.0 mm.

17. The forming fabric according to claim 16, wherein said height is approximately 0.1 mm.

18. The forming fabric according to claim 1, wherein said woven fabric having said polymer material deposit has a permeability between approximately 50 cfm and approximately 1,200 cfm.

19. The forming fabric according to claim 18, wherein said woven fabric having said polymer material deposit has a permeability between approximately 200 cfm and approximately 900 cfm.

20. The forming fabric according to claim 19, wherein said woven fabric having said polymer material deposit has a permeability between approximately 300 cfm and approximately 800 cfm.

21. The forming fabric according to claim 1, wherein the fabric is used on an advanced dewatering system.

22. A forming fabric for an advanced dewatering system, the forming fabric comprising:
a woven fabric having a paper side and a roll side, said paper side having a paper side surface and said roll side having a roll side surface; and
a polymer material deposit extending above said paper side surface, said polymer material deposit having at least one of a random pattern, a random motif, a pseudo-random pattern, a pseudo-random motif, a predetermined pattern and a predetermined motif.

23. A method of forming a structured fibrous web, said method comprising the steps of:
supplying a fiber slurry to a nip, said nip being formed by a structured fabric and a forming fabric;
dewatering said fiber slurry through said forming fabric to create a web;
retaining the web with said structured fabric through at least one dewatering process, said forming fabric including a woven fabric having a paper side and a roll side, said paper side having a paper side surface and said roll side having a roll side surface;
providing a polymer material deposit extending above said paper side surface, said polymer material deposit having at least one of a random pattern, a random motif, a pseudo-random pattern, a pseudo-random motif, a predetermined pattern and a predetermined motif.

24. The method according to claim 23, wherein said polymer material deposit is at least one of an RTY-type material, an RTV-type heat curable material, an acrylic, an epoxy resin, a silicone, a polyurethane, a hydrosol, a polyolefin, UV curable, a natural rubber, a synthetic rubber, nanopolymers, carbon fullerenes, dendrimers, polymers loaded with carbon, polymers loaded with metals, electrically conducting polymers, semi-conductors, liquid crystal polymers, hot melts, polymers that are sensitive to pressure, polymers that are sensitive to light, polymers that are sensitive to temperature, reactive polymers and living polymers.

25. The method according to claim 24, wherein said structured fabric has peaks and valleys, said structured fabric further comprising a plurality of yarns woven together having a mesh count and a weave pattern, said weave pattern including said valleys being from approximately 0.07 mm to approximately 0.60 mm deep and said mesh count being between 95×120 and 26×20 per square inch.

26. The method according to claim 25, further comprising the step of substantially collecting fibers of said fiber slurry in a plurality of said valleys of said structured fabric.

27. The method according to claim 26, further comprising the step of dewatering said fiber slurry through said forming fabric and not through said structured fabric.

28. The method according to claim 27, wherein said step of collecting said fibers of said fiber slurry further includes the step of forming a structured web.

29. The method according to claim 28, wherein said structured web has a pillow thickness formed in said valleys and a top surface thickness formed on said peaks, said pillow thickness being one of equal to and greater than said top surface thickness.

30. The method according to claim 29, wherein said structured web has a pillow basis weight formed in said valleys and a top surface basis weight formed on said peaks, said pillow basis weight being one of equal to and greater than said top surface basis weight.

31. The method according to claim 30, further comprising the steps of removing said forming fabric from said structured web and contacting said structured web with a dewatering fabric and removing moisture from said structured web through said dewatering fabric.

32. The method according to claim 31, further comprising the steps of:
applying pressure against a contact area of said fibrous web with a portion of a permeable belt, said contact area being at least approximately 10% of an area of said portion; and
moving a fluid through an open area of said permeable belt and through said fibrous web, said open area being at least approximately 25% of said portion, said permeable belt having a tension of at least approximately 30 KN/m during said step of applying pressure and said step of moving said fluid.

33. The method according to claim 32, further comprising the steps of:
applying pressure against a contact area of said fibrous web with a portion of a permeable belt, said contact area being at least approximately 25% of an area of said portion; and
moving a fluid through an open area of said permeable belt and through said fibrous web, said open area being at least approximately 25% of said portion, said permeable belt having a tension of at least approximately 30 KN/m during said step of applying pressure and said step of moving said fluid.

34. The method according to claim 33, wherein during said steps of applying pressure and moving fluid, said structured fibrous web is positioned between said structured fabric and said dewatering fabric, said permeable belt contacting said structured fabric and said dewatering fabric contacting a surface of a roll, said pressure being applied through said structured fabric to said fibrous web and said fluid moving first through said fibrous web and second through said dewatering fabric.

35. The method according to claim 34, wherein said tension is greater than approximately 60 KN/m.

36. The method according to claim 35, wherein said step of applying pressure and said step of moving said fluid occur for a dwell time sufficient to produce a fibrous web solids level in a range between approximately 25% to approximately 55%.

37. The method according to claim 36, wherein said dwell time is one of equal to and greater than approximately 40 ms.

38. The method according to claim 37, wherein said dwell time is one of equal to and greater than approximately 50 ms.
